(19) United States
(12) Patent Application Publication
(10) Pub. No.: US 2010/0299720 A1
(43) Pub. Date: Nov. 25, 2010

(54) METHOD AND APPARATUS FOR CONVENIENT CONNECTING AND DISCONNECTING OF INTERNET FROM A COMPUTER

(75) Inventors: Eugene Britto John, Austin, TX (US); Lizy Kurian John, Austin, TX (US)

Correspondence Address: Eugene John, 4020 Vivas Ln, Austin, TX, 78735, US

(73) Assignee: TEXAS DIGITAL AND MULTIMEDIA SYSTEMS, Austin, TX (US)

(21) Appl. No.: 12/471,359

(22) Filed: May 23, 2009

(51) Int. Cl. G06F 21/00; G06F 1/26

(52) U.S. Cl. 726/3; 713/300

(57) ABSTRACT

The present invention discloses a convenient method for easily disconnecting and connecting internet to/from a computer. Instead of plugging and unplugging the physical cable that connects to the internet, a facility is invented to conveniently connect and disconnect internet using a switch on an internet cable or a convenient switch on the keyboard or monitor/display or the computer housing/box itself. Instead of pressing a switch, a key or swipe card can be used to activate the switch. Alternately the internet connection can be activated by opening a browser. The invention can be integrated into the browser to disable the internet connection during periods of inactivity. The key or swipe card can additionally be used to implement access restrictions, for instance controlling hours of access or disallowed sites for a child.

### FIELD OF INVENTION

The present invention discloses a convenient method for easily disconnecting and connecting internet to/from a computer. Instead of plugging and unplugging the physical cable that connects to the internet, a facility is invented to conveniently connect and disconnect internet using a switch on an internet cable or a convenient switch on the keyboard or monitor/display or the computer housing/box itself. Instead of pressing a switch, a key or swipe card can be used to activate the switch. Alternately the internet connection can be activated by opening a browser. The invention can be integrated into the browser to disable the internet connection during periods of inactivity. The key or swipe card can additionally be used to implement access restrictions, for instance controlling hours of access or disallowed sites for a child.

### BACKGROUND OF THE INVENTION

Many computers are permanently connected to the internet via physical cables. Irrespective of whether the internet connection is used by the user or not, the connection is often always ON 24/7. This permanently ON internet connection makes the computer more vulnerable to malicious attacks. Many users like to disconnect internet connections while leaving their desks for longer time periods so that viruses and other invasive attacks via the internet can be prevented. Some users like to turn off internet every night when they go to bed. If the computer is connected to the internet only when it is used, the vulnerability to malicious attacks may be proportionately reduced. Usually it is inconvenient to turn off internet by pulling off the cable from the computer or the wall. The wall switch may be inaccessible or not conveniently accessible. It might be inconvenient to physically go to the back of the computer or the wall outlet each time you want to reconnect/disconnect. There may be more than one wall outlet and when the person has to connect it back, one may make a mistake connecting to the wrong outlet. The cable will get increased wear and tear by physically plugging and unplugging too often. There are several such inconveniences associated with physically plugging and unplugging the internet connection.

### SUMMARY OF THE INVENTION

In view of the advantages of connecting the computer to the internet only when connection is needed and in view of the shortcoming of physically plugging/unplugging the internet cable to the computer each time, the objective of the present invention is to provide a convenient mechanism for turning on/off internet connection without physically plugging on/off the internet cable from either the computer or the wall.

For the purposes of this specification, the term “computer” refers to broadly to any computer. It includes laptops, netbooks, notebooks, desktops, servers and any other computers.

For the purposes of this specification, the term “internet data conduit” refers to a conduit that carries data to and from the internet. The data can be in any form, such as analog or digital. And the conduit can carry data in electrical, fiber optic or any other form.

For the purposes of this specification, the term “data conduit disconnect apparatus” refers to a mechanism for severing the transmission of data along a data conduit. The data conduit disconnect apparatus can consist of switches that make and break the flow of data on the conduit.

For the purposes of this specification, the term “activation switch” refers broadly to any switch that can be used to activate the data conduit disconnect apparatus. The term switch refers to any type of switch, including but not limited to a mechanical switch, an electrical switch, or a software driven switch. As discussed below, the switch could be located in any location on the system, including but not limited to being located on the disconnect apparatus, the data conduit, the computer, the computer's keyboard, the computer's screen, the computer mouse, a remote control, voice activation system, or a swipe card.

### BRIEF DESCRIPTION OF THE DRAWINGS

FIG. 1. Data conduit disconnect apparatus integrated to an internet cable

FIG. 2. An internet activation switch integrated into a computer keyboard to physically connect or disconnect the internet. Not all keys in the keyboard are shown in the drawing.

FIG. 3. An internet on/off activation switch integrated to a computer monitor/display

FIG. 4. An internet on/off activation switch integrated to the computer housing

### DETAILED DESCRIPTION OF THE PREFERRED EMBODIMENT

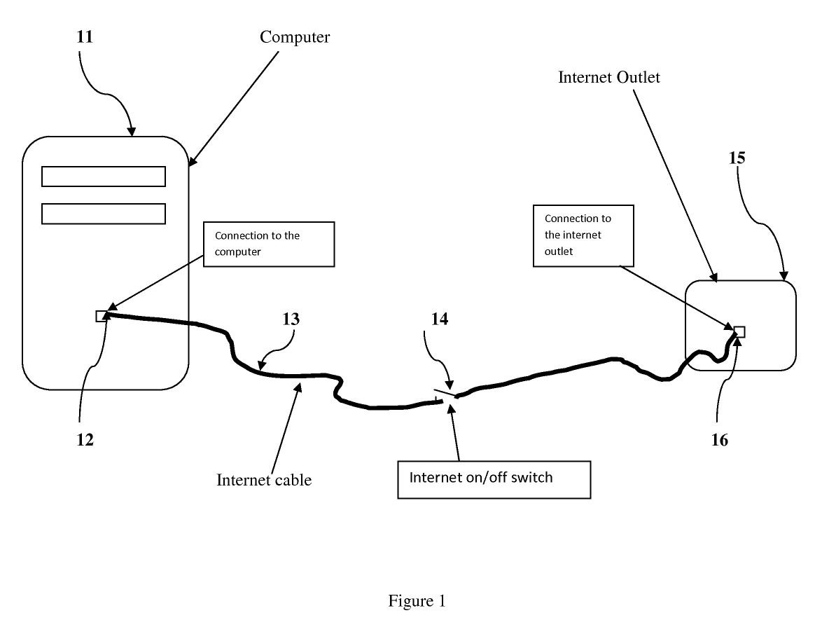

FIG. 1 illustrates a preferred embodiment of this invention, primarily illustrating the data conduit disconnect apparatus. A computer 11 is connected to internet outlet 15 using the jack 16 at the end of an internet cable 13. A switch 14 is integrated to an internet cable 13 in an easily accessible location. The internet cable 13 makes a connection between internet access point 12 on the computer to internet connection point 16 on the internet outlet. The switch 14 selectively connects and/or disconnects one or more conductors between the computer and the internet outlet. Several switches controlled by one user activation mechanism can be used to control the connection between the various conductors forming the cable. The switch(es) can be mechanical or electronic, push button or circular dial type or pulling type or any other type of switch known in the art. The switch can be turned on/off by contact or remote control. The switch can be voice activated or contact activated or remote control activated by infra-red or another such technology known in the art. A housing can be built to house switch 14, and the housing can be kept on the desk in an accessible location so that internet can be conveniently connected and/or disconnected. The embodiment as presented in FIG. 1 makes it possible to use this invention with existing computers. The computer in use with this invention can be a desktop, notebook, laptop, netbook or any other computer.

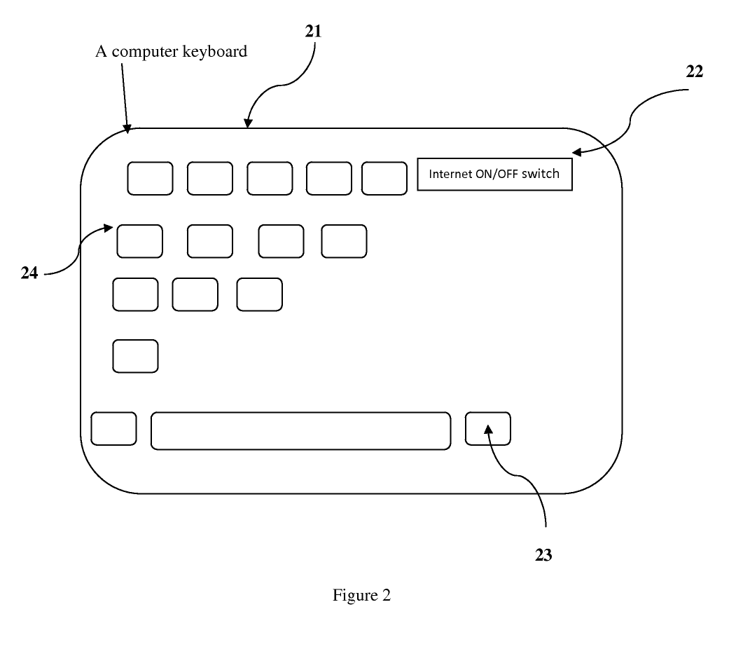

FIG. 2 shows another preferred embodiment of the invention focusing on the activation mechanism, where the activation switch 22 is integrated to the computer keyboard 21. This can be similar to a regular key such as the CAPS LOCK key 24 on standard keyboards or it can be a switch like the power on/off switch (sleep on/off switch) 23 on some keyboards. The key can be located in any part of the keyboard unit. It can even be located in a not-so visible part in order to hide internet control from children. The switch can also be located such that it does not get turned on/off unintentionally. The switch can also be integrated to the computer mouse. The switch 22 when controlled by the user enables the closing and opening of switch 14. Switch 22 is thus the activation mechanism. In another embodiment, switch 22 can be the same switch 14, i.e. a switch in the middle of the cable is brought in to the keypad for convenient access.

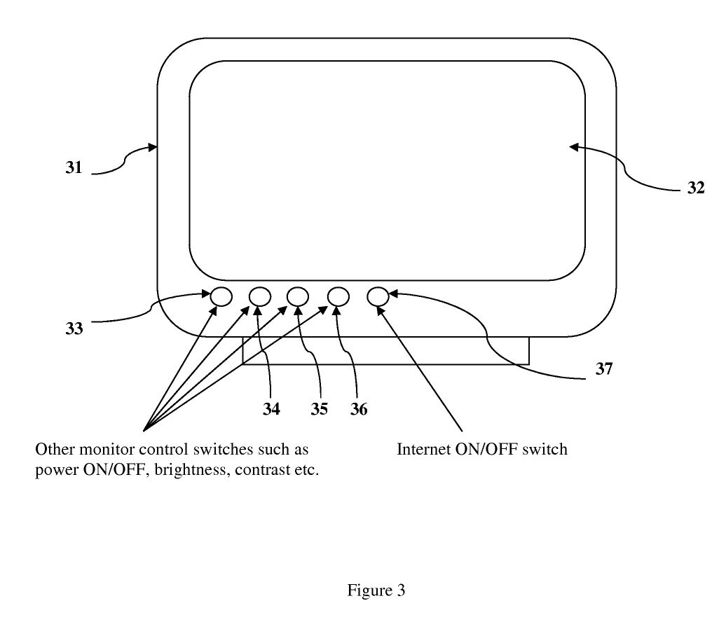

FIG. 3 shows another illustration of the activation mechanism where the activation switch is integrated to the computer monitor or display unit 31. Some display units have controls 33, 34, 35, 36 for controlling brightness or contrast or other features of the screen 32. The additional internet on/off activation mechanism 37 will be located on the display unit as well. It can be on the front of the display or side or any part of the display unit. It can even be located in a not-so visible part in order to hide internet control from children. The activation mechanism can also be located such that it does not get turned on/off unintentionally. The activation mechanism can be a soft switch/key.

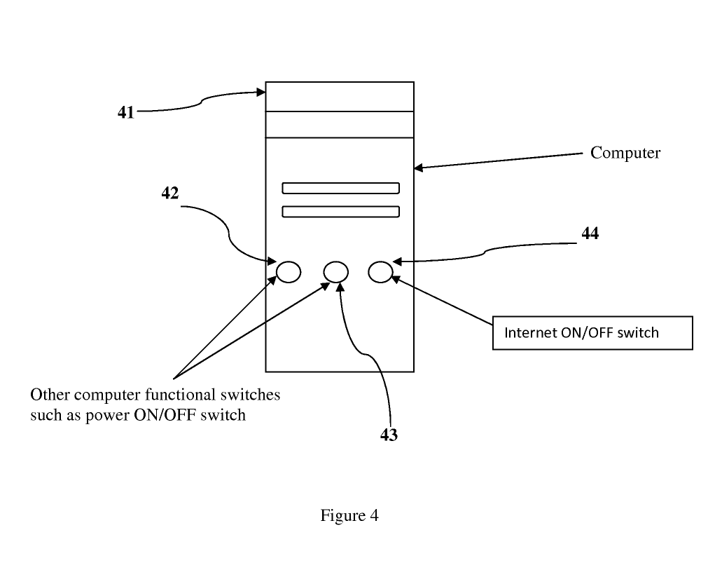

FIG. 4 shows another illustration of the activation mechanism where the internet activation switch 44 is located on the computer unit 41 itself. Most users keep the computer in such a way that the front panel is accessible, so that they can access functional switches such as the power on/off switch 42. The internet on/off switch 44 can also be located on the front panel. But another face of the computer box may be suitable for another user. Hence the main computer front panel or any of the faces of the box/unit can house the switch 44. It can even be located in a not-so visible part in order to hide internet control from children. The activation switch can also be located such that it does not get turned on/off unintentionally.

The invention thus consists of a data conduit disconnect apparatus to facilitate the connection and/or disconnection and an activation mechanism for the user to activate the disconnect apparatus. In some embodiments, the disconnect apparatus and the user activation mechanism can be integrated together, eg: a mechanical switch located on the internet cable which when pressed by the user connects/disconnects the internet. In other cases, a mechanical switch located on a convenient location on the computer, when pressed, generates an electrical signal, which in turn will activate the data conduit disconnect apparatus, which may be a switch located elsewhere. In another embodiment, this switch is located on the wall, near the internet jack.

The activation mechanism can also be a key operated switch. In this embodiment of the invention, the user inserts a key into a keyhole to turn on the internet connection. The key is removed to turn off the internet connection. In another embodiment of the invention, the user inserts a key into a keyhole and turns the key clockwise or counterclockwise to turn ON the internet connection. Once turned, the key may be required to stay in the keyhole. Alternately, in another implementation, the key does not need to stay in the keyhole to continue to activate the internet connection. Different such implementations are possible. The keyhole can be integrated into the keyboard, monitor, computer housing or mouse or can be a part of the connecting cable (for example in a small housing half-way on the cable). The computer housing refers to the box or other structure that houses the computer.

In another embodiment of the invention, a swipe card is used instead of a key. The swipe card can look like a credit card with a magnetic strip or a computer chip. The slot to swipe the card can be located on the keyboard or monitor or computer housing or the mouse. The key can be made of any material such as but not limited to metal, plastic, wood, or an electronic key which has embedded circuitry in it. Swiping the card activates/deactivates the internet connection.

It is useful to have internet access restrictions for different users. For instance, children can be restricted from using internet after 10 pm. Similarly, children may have to restricted from certain sites. It is possible to create restricted access to the internet by coding access restriction information into the swipe card. It is also possible to create restricted access environment by storing information on access restrictions and linking it to finger prints, or particular swipe cards, or keys or voice. The predetermined previleges of users include but not limited to specific hours of the day or specific sites prevented from visiting and such other things.

The swipe card or the key can store additional information for limited or controlled access. For instance, children's keys can be programmed with restrictions to control the hours they are allowed internet access or sites they are prohibited from accessing. When users buy computers from vendors, it can come with adult keys (adult swipe cards) and children's keys (children's swipe cards). While Hunter disclosed in U.S. Pat. No. 6,599,139 a timer mechanism to control children's access to phone/cable, no prior art discloses a convenient mechanism such as a key/swipe card to control access and provide different levels of internet access on the same computer.

This invention is applicable to wired and wireless internet connections. In the case of the wireless internet, the user controlled switch 22, 37 or 44 send signals to turn off the wireless unit housed in the computer. Chiang et al (U.S. Pat. No. 7,181,238) presents a latch mechanism to shut off wireless communication from a laptop. Disconnecting internet from laptops using wired internet connections was not covered by Chiang U.S. Pat. No. 7,181,238. In Chiang U.S. Pat. No. 7,181,238, in order to shut off wireless communication, the laptop has to be closed, which prevents the user from using the computer after shutting off the internet. It is very useful to have a laptop be open and functional, users to be able to do activities that do not need internet ( eg: word processing, offline games, etc) after disconnecting the internet. Hence a laptop that uses the invention in Chiang can still benefit from the invention being described here. The current invention is applicable to laptop and desktop computers. The internet switch, swipe card and controlled access key are applicable for laptop and desktop computers, wired and wireless internet connections.

The internet activation switch can be activated using a remote control. When the switch is integrated to the keyboard or computer or display, if the external internet cable has a switch, then the integrated switch can remotely control the switch on the cable. But the switch on the computer/keyboard/monitor can be built into the computer or keyboard or monitor or mouse so that the computer can be connected to the internet without any special cable.

The switch can be a soft switch on the display. The soft switch can be made available from a pop-up menu or a menu with radio buttons (similar to volume control radio buttons). The switch can be integrated into the operating system or web browsers. When the browser is opened, it will send a signal to turn ON the internet connection automatically and when the browser is closed it will send a signal to turn OFF the internet. For systems where access control is activated or deactivated using a swipe card, if the user has swiped a card that provides appropriate previleges, the switch can be integrated into the browser in such a way that when the browser is opened, it will send a signal to turn ON the internet connection automatically and when the browser is closed it will send a signal to turn OFF the internet. An additional improvement will be to detect a browser that is inactive for a certain amount of time and trigger the turn OFF of the internet activation mechanism.

There are some computers where the main computer unit is integrated to the display. And computers of different form factors are expected to appear. Hence the location of the switch can be changed to suit the form factor of the computer. The invention is about the use of the conveniently accessible switch itself without the need to plug and unplug cables.

What is presented in this invention is an internet activation and/or deactivation system comprising of an activation mechanism built into a computer keyboard/mouse/monitor/computer housing/internet cable in such a way that the computer can be connected/disconnected to/from the internet by a key press/key stroke without physically plugging/unplugging the internet cable. The terms switch and key have been used interchangeably in many parts of this description. The term key may be denoting a key as on a keyboard or a mechanical key that is turned to open/close a lock. While the invention has been described in terms of preferred embodiments, it is not limited to specific examples presented here. It is intended to cover various modifications and similar arrangements and mechanisms.

What is claimed is:
A system for disconnecting a computer from the internet, the system comprising,
   a computer, an internet data conduit, a data conduit disconnect apparatus, and an activation mechanism,
   the data conduit disconnect apparatus comprising a first mode permitting data to flow through the conduit and a second mode preventing data from flowing through the conduit,
   wherein the data conduit disconnect apparatus is connected or integrated to the internet data conduit,
   wherein activating the activation mechanism changes the mode of the data conduit disconnect apparatus,
   wherein the computer can be connected or disconnected from the internet by the activation switch, and wherein the mode of the data conduit apparatus does not interfere with the computer's non-internet related operations.
The system of claim 1 further comprising an internet browser, wherein opening the browser automatically activates the first mode of the data conduit disconnect apparatus.
The system of claim 1 further comprising an internet browser, wherein closing the browser automatically activates the second mode of the data conduit disconnect apparatus.
The system of claim 1 further comprising a software application program operating on the computer, the software application program monitoring whether any internet application is in use, and if no internet application is in use the software application program instructs the activation mechanism to activate the second mode of the data conduit disconnect apparatus.
The system of claim 1 where the internet data conduit is a wired internet connection.
The system of claim 1 where the computer uses a wireless internet connection.
A system as in claim 1 where the data conduit is fiberoptic.
A system as in claim 1, where the activation mechanism comprises a swipe card system, wherein swiping the card changes the mode of the data conduit disconnect apparatus.
A system as in claim 1, where the activation mechanism comprises a finger print reader mechanism, where switching the modes uses finger print matching.
The system as in claim 1, where the activation mechanism comprises a voice recognition system, where the switching of the modes uses voice matching.
The system as in claim 1 where the activation mechanism consists of buttons on a remote control.
The system as in claim 1 where the activation mechanism is located on the keyboard of the computer.
The system as in claim 1 where the activation mechanism is located on the computer housing.
The system as in claim 1 where the activation mechanism is located on the computer monitor.
The system as in claim 1 where the system further comprises a network card, where the activation mechanism consists of disconnecting power from the network card.
The system as in claim 1 where the activation mechanism consists of inserting a key into a keyhole.
The system as in claim 1 where the activation mechanism consists of inserting a key into a keyhole and turning it.
The system as in claim 1 where the activation mechanism disconnects at least 1 conductor between the computer and the internet outlet.
The system as in claim 1 where the activation mechanism disconnects at least 2 conductors between the computer and the internet outlet.
A system as in claim 1, further restricting the internet activation to predetermined previleges.
A system for disconnecting a computer from the internet, the system comprising,
   a computer, a network card, an internet deactivation apparatus and an activation mechanism,
   wherein the network card generates data in the appropriate format for the internet,
   wherein the internet deactivation apparatus comprises a first mode permitting the network card to send and/or receive data to/from the internet, and a second mode inhibiting the network card from sending and/or receiving data to/from the internet,
   wherein the activation mechanism changes the mode of the internet deactivation apparatus,
   wherein the computer can be connected or disconnected from the internet by the activation mechanism, and wherein the mode of internet deactivation apparatus does not interfere with the computer's non-internet related operations.
A system as in claim 21, where the computer uses a wired internet connection.
A system as in claim 21, where the internet deactivation apparatus/mechanism consists of a user accessible mechanism to selectively turn off power to the network card without turning the computer off.
A system as in claim 21, further comprising switches to severe the connection between the network card and the internet conduit.
A system as in claim 21 where the internet deactivation apparatus consists of a user accessible switch to turn off connection between the network card and the internet conduit.

### References

U.S. Pat. No. 7,181,238 B2—Chuen-Lin Chiang, Structure for Turning On/Off Wireless Communication of notebook computer by latch member
U.S. Pat. No. 6,599,139—Hunter, Timer Connect-Disconnect for Telephone, cable and Network Connections,

What is claimed is:

1. A system for disconnecting a computer from the internet, the system comprising,
a computer, an internet data conduit, a data conduit disconnect apparatus, and an activation mechanism,
the data conduit disconnect apparatus comprising a first mode permitting data to flow through the conduit and a second mode preventing data from flowing through the conduit,
wherein the data conduit disconnect apparatus is connected or integrated to the internet data conduit,
wherein activating the activation mechanism changes the mode of the data conduit disconnect apparatus,
wherein the computer can be connected or disconnected from the internet by the activation switch, and wherein the mode of the data conduit apparatus does not interfere with the computer's non-internet related operations.

2. The system of claim 1 further comprising an internet browser, wherein opening the browser automatically activates the first mode of the data conduit disconnect apparatus.

3. The system of claim 1 further comprising an internet browser, wherein closing the browser automatically activates the second mode of the data conduit disconnect apparatus.

4. The system of claim 1 further comprising a software application program operating on the computer, the software application program monitoring whether any internet application is in use, and if no internet application is in use the software application program instructs the activation mechanism to activate the second mode of the data conduit disconnect apparatus.

5. The system of claim 1 where the internet data conduit is a wired internet connection.

6. The system of claim 1 where the computer uses a wireless internet connection.

7. A system as in claim 1 where the data conduit is fiberoptic.

8. A system as in claim 1, where the activation mechanism comprises a swipe card system, wherein swiping the card changes the mode of the data conduit disconnect apparatus.

9. A system as in claim 1, where the activation mechanism comprises a finger print reader mechanism, where switching the modes uses finger print matching.

10. The system as in claim 1, where the activation mechanism comprises a voice recognition system, where the switching of the modes uses voice matching.

11. The system as in claim 1 where the activation mechanism consists of buttons on a remote control.

12. The system as in claim 1 where the activation mechanism is located on the keyboard of the computer.

13. The system as in claim 1 where the activation mechanism is located on the computer housing.

14. The system as in claim 1 where the activation mechanism is located on the computer monitor.

15. The system as in claim 1 where the system further comprises a network card, where the activation mechanism consists of disconnecting power from the network card.

16. The system as in claim 1 where the activation mechanism consists of inserting a key into a keyhole.

17. The system as in claim 1 where the activation mechanism consists of inserting a key into a keyhole and turning it.

18. The system as in claim 1 where the activation mechanism disconnects at least 1 conductor between the computer and the internet outlet.

19. The system as in claim 1 where the activation mechanism disconnects at least 2 conductors between the computer and the internet outlet.

20. A system as in claim 1, further restricting the internet activation to predetermined previleges.

21. A system for disconnecting a computer from the internet, the system comprising,
a computer, a network card, an internet deactivation apparatus and an activation mechanism,
wherein the network card generates data in the appropriate format for the internet,
wherein the internet deactivation apparatus comprises a first mode permitting the network card to send and/or receive data to/from the internet, and a second mode inhibiting the network card from sending and/or receiving data to/from the internet,
wherein the activation mechanism changes the mode of the internet deactivation apparatus,
wherein the computer can be connected or disconnected from the internet by the activation mechanism, and wherein the mode of internet deactivation apparatus does not interfere with the computer's non-internet related operations.

22. A system as in claim 21, where the computer uses a wired internet connection.

23. A system as in claim 21, where the internet deactivation apparatus/mechanism consists of a user accessible mechanism to selectively turn off power to the network card without turning the computer off.

24. A system as in claim 21, further comprising switches to severe the connection between the network card and the internet conduit.

25. A system as in claim 21 where the internet deactivation apparatus consists of a user accessible switch to turn off connection between the network card and the internet conduit.
